(19) United States
(12) Patent Application Publication
(10) Pub. No.: US 2018/0096379 A1
(43) Pub. Date: Apr. 5, 2018

(54) Methods and systems for estimating Click-Through-Rate for a SERP layout

(71) Applicant: Iquanti Inc., Jersey City, NJ (US)

(72) Inventors: Ajay Kumar Rama, Bangalore (IN); Geetha Sai Krishna, Bangalore (IN)

(73) Assignee: Iquanti Inc., Jersey City, NJ (US)

(21) Appl. No.: 15/285,486

(22) Filed: Oct. 5, 2016

(51) Int. Cl. G06Q 30/02; H04L 29/08; G06Q 10/04

(52) U.S. Cl. CPC G06Q 30/0242; H04L 67/22; G06Q 30/0251; G06Q 30/0248; G06Q 10/04

(57) ABSTRACT

Methods and systems for estimating Click-Through-Rate. This invention relates to the Internet and more particularly to analyzing traffic on the Internet. Embodiments herein disclose methods and systems for estimating CTR (Click-Through-Rate) for a SERP (Search Engine Results Page) layout. Embodiments herein also disclose methods and systems for estimating CTR (Click-Through-Rate) for a SERP (Search Engine Results Page) layout, by considering the SERP attributes such as keyword, position of the ranking link, and so on.

### TECHNICAL FIELD

Embodiments herein relate to the Internet and more particularly to analyzing traffic on the Internet.

### BACKGROUND

Technology today has helped users to get information at tap of the button. This has changed the way users consume the information. Technology/Search engines have evolved and are evolving in to serve this change. For example, let us assume that user uses Google to perform a search for “what is collision insurance” has an intention to know what it means. Without even clicking on any of the links that are ranked by Google, the user can see the information in the box (answer box) that is placed above all the ranked results. Similarly keywords that are time sensitive (TV ratings, game scores, and so on), the information they carry varies from time to time and the user may want to know the latest information. In these cases, Google clusters all the news/updates into a single unit and displays in the SERP (Search Engine Results Page) layout. Some keywords can be brand sensitive and the search engine can present users with a relevant set of brand links clustered at top of the organic results. In many such ways, search engines are providing users with relevant search results in a customizable fashion. Presence of one or combination of all such packs (answer box, news, image, brand packs, and so on) is named as Blended SERP.

With so much customization for each query, user behavior changes when the user is presented with an unaccustomed set of mixes. Usually brands/business estimates the traffic based on the position they rank in the organic results in the SERP. But any such estimate would no longer be valid. As an example, a user might just consume information presented in the answer box and the user might feel satisfied, in such cases even though someone is ranking at position one will not be able to get the advantage of increased traffic. All those studies which estimate the traffic based on the position are no longer relevant & provide inaccurate estimates.

Predicting CTR (Click-Through-Rate) has been of interest for many companies/agencies in the Search engine optimization space. Previous studies have attempted to predict the CTR at different positions. Advanced web ranking study helps to infer the CTR for different industries and categories. But none of those studies have been able throw light on effect of the different mix of results the search engine presents on the user click behavior.

Google has been used merely as an example herein, and the above mentioned examples may be applicable for other search engines (such as Bing, Yahoo, Baidu, DuckDuckGo, and so on).

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a system for estimating the CTR, according to embodiments as disclosed herein;

FIG. 2 is a flowchart depicting the process of estimating the CTR, according to embodiments as disclosed herein;

FIG. 3 depicts the CTRE module, according to embodiments as disclosed herein;

FIG. 4 illustrates a plurality of components of an electronic device for estimating the CTR, according to embodiments as disclosed herein; and

FIGS. 5a and 5b depict an example of a SERP, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

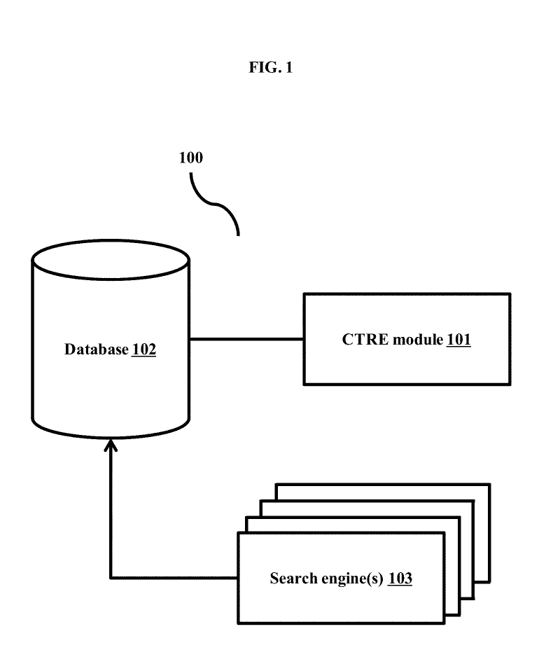

The embodiments herein achieve methods and systems for estimating CTR (Click-Through-Rate) for a SERP (Search Engine Results Page) layout. Referring now to the drawings, and more particularly to FIGS. 1 through 4, where similar reference characters denote corresponding features consistently throughout the figures, there are shown preferred embodiments.

CTR can be defined as the ratio of users who click on a specific link to the number of total users who view the SERP.

Embodiments herein consider that the CTR can depend on factors such as the keyword, the mix of results presented to a user performing the search, and so on.

The mix of results can comprise of

Answer Box: A box that appears above all the organic results in the SERP, and contains the information related to query.
Brand Pack: A cluster of results from the same website. It presents the main link, other site links that user might be interested in.
Image Pack: Few queries result in the cluster of images with a link
News Pack: Few queries are time sensitive and users may want to get the most updated information on the topic of interest and the search engine can provide them through this news packs.
People also ask pack: Search engines helps users to consume more information related to a topic by providing more links on what other people consume on a particular topic.
Local packs: Some queries such as “restaurants near me” results in those restaurants near user along with provision to click and view those results in Map, such results in SERP are Map packs.
Micro format: Presence of the micro-formatting around the link i.e., ratings etc. will also have an impact on the click behavior on the link and also on the links around it.

The above mentioned mix of results can be considered as examples herein, and the mix of results can comprise of other results, as configured by at least one of the search engine and/or a user.

The keyword provided by the user can have parameters such as Number of tokens in query: Total number of words/tokens in the keywords represents characteristics of the keyword.

Popularity of the keyword (Search volume of the query): Search volume of the keyword represents how popular some specific query is among the users, queries with more search volume represent the information consumption and click behavior differs accordingly.
Competition: This represents the number of advertiser's worldwide bidding on each keyword relative to all keywords across Google. It helps us to identify such keywords with purchase intent quantitatively.
Branded/Non branded: Classification of whether a keyword is branded or Non branded also plays an important role in the click behavior of the user in SERP.

Conversions as referred to herein can comprise of types of conversions such as purchase/sales, downloading a report, filling a lead generation form and so on.

FIG. 1 depicts a system for estimating the CTR. The system 100, as depicted, comprises of a CTRE (CTR Estimation) module 101, at least one database 102, and at least one search engine 3. The database 102 can comprise of information such as the webmasters data of various organizations/entities, a mix of results present at one or more dates, data related to the layout of the SERP, and search volume and competition data related to keywords/AdWords. The database 102 can comprise of data from search engine(s) 103 received in real time.

In an embodiment herein, the CTRE module 101 can be a centralized module. In an embodiment herein, the CTRE module 101 can be a distributed module. The CTRE module 101 can be connected to the database 102 using a suitable wired and/or wireless means.

The CTR module 101 can fetch data from the database 102. Based on the fetched data, the CTRE module 101 can build a predictive model. The CTRE module 101 can use the predictive model to estimate traffic to a webpage. The CTRE module 101 can use historical data and the predictive model to estimate conversions/leads based on traffic. The CTRE module 101 can further estimate the total sales from the leads.

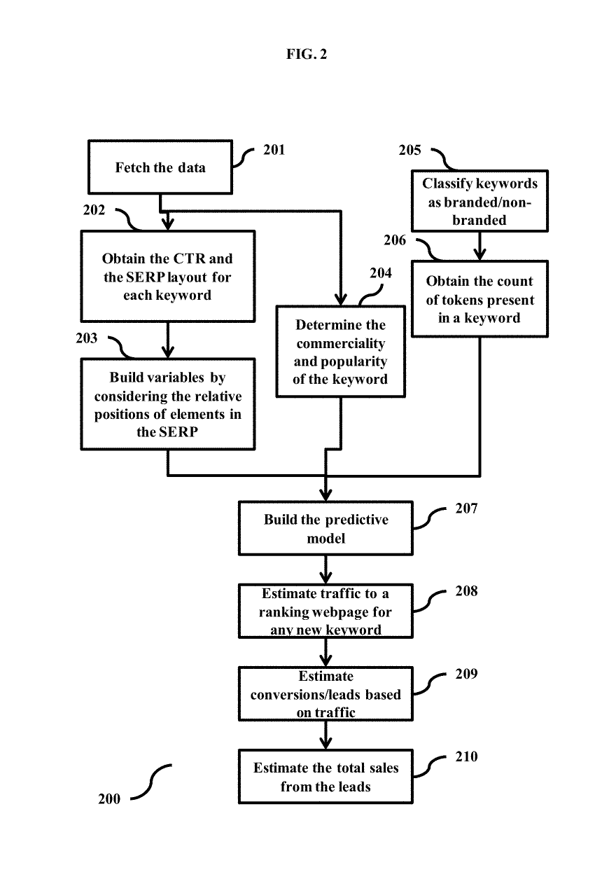

FIG. 2 is a flowchart depicting the process of estimating the CTR. In step 201, the CTRE module 101 fetches the data comprising of the webmasters data of various organizations/entities, the data related to the layout of the SERP, and the search volume and competition data related to keywords from adwords from the database 102. In step 202, the CTRE module 101 obtains the CTR and the SERP layout for each keyword by mapping the data from the webmasters data of various organizations/entities, and the data related to the layout of the SERP. In step 203, the CTRE module 101 builds variables by considering the relative positions of elements in the SERP, based on the mapped data. This enables the CTRE module 101 to capture impact of various packs on the CTR. Using the search volume and competition data related to keywords from adwords in step 204; the CTRE module 101 determines the commerciality and popularity of the keyword. In step 205, the CTRE module 101 classifies keywords as branded/non-branded and in step 206, obtains the count of tokens present in a keyword. In step 207, the CTRE module 101 builds the predictive model by combining the built variables and the determined commerciality, the popularity of the keyword and count of tokens. In step 208, the CTRE module 101 uses the predictive model to estimate traffic to a ranking webpage for any new keyword. Traffic to a page is a function of the search volume for the keyword and the CTR. For example, the search volume of a keyword ‘Puma Shoes’ is 50000 and a specific page of interest ranks on position 5. The CTR associated with ‘Puma Shoes’ and position 5 is calculated based on the model as disclosed herein. Traffic for the page of interest can be estimated as 50000*CTR. In step 209, the CTRE module 101 estimates conversions/leads based on traffic by using historical data and the predictive model. The CTRE module 101 can obtain the conversion rate of the page from the page level analytics data. The CTRE module 101 can estimate the conversion as the product of the traffic to a page and the conversion rate of the page. In step 210, the CTRE module 101 further estimates the total sales from the leads. The CTRE module 101 can obtain the sales rate from the page level analytics data. The CTRE module 101 can estimate the sales as the product of the traffic to a page and the sales rate of the page. The various actions in method 200 may be performed in the order presented, in a different order or simultaneously. Further, in some embodiments, some actions listed in FIG. 2 may be omitted.

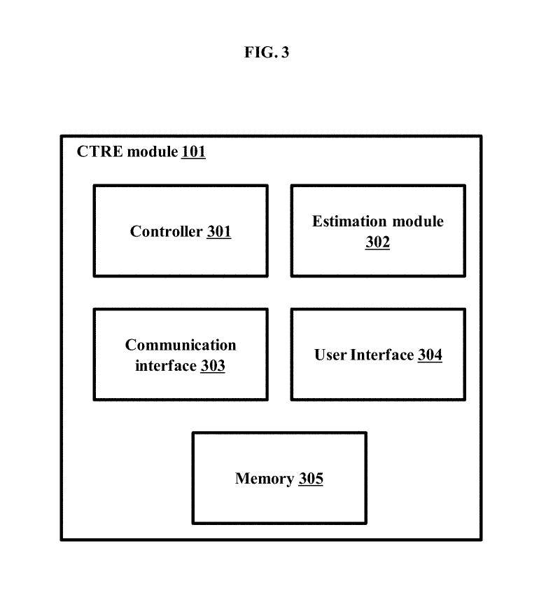

FIG. 3 depicts the CTRE module. The CTRE module 101, as depicted, comprises of a controller 301, an estimation module 302, at least one communication interface 303, at least one user interface 304, and a memory 305. The at least one communication interface 303 can be a wired interface and/or a wireless interface. The communication interface 303 can be used to communicate with external entities such as the database 102, and so on. The user interface 304 can comprise at least one of a display, a keyboard, a mouse, another device, or any other interface, which enables an authorized user to interact with the CTRE module 101. The memory 305 can comprise of a co-located memory. The memory 305 can be located remotely from the CTRE module 101. Examples of the memory 305 can be a RAM (Random Access Memory), a ROM (Read Only Memory), a file server, a data server, an online storage means, the Cloud, or any other equivalent means.

The controller 301 can fetch the data from the database 102 using the communication interface 303. The controller 301 can fetch at least one of the data directly from the source; for example, the webmasters repository/storage/space/server, and so on. The controller 301 can perform regression analysis on the data to determine a coefficient, βᵢ. Considering an example where there are 19 different types of results present in the SERP, the controller 301 can estimate coefficients, β1, β2, β3, . . . , β19. After collecting data from multiple sources, the controller 301 can perform linear regression using ordinary least squared method to estimate the coefficients, wherein the parameters can be estimated by minimizing the squared difference between the actual CTR and predicted CTR. The controller 301 can determine the custom variable for each element of the SERP (such as news, answer pack, brand pack, images, and so on) as

Pack Variable=(absolute(Position_{pack}−Position_{prediction})⁻¹)

If news is present in the SERP, the controller 301 can determine the variable as

if news is present then absolute(Position_{news}−Position_{prediction})⁻¹) else 0

If a brand pack is present in the SERP, the controller 301 can determine the variable as

if brandpack is present then absolute(Position_{brandpack}−Position_{prediction})⁻¹) else 0

Consider an example where the brand pack is present at position 1, the controller 301 can determine the variable as

if brandpack is present then absolute(1−Position_{prediction})⁻¹) else 0

If image(s) are present in the SERP, the controller 301 can determine the variable as

if image is present then absolute(Position_{image}−Position_{prediction})⁻¹) else 0

If a local pack (such as maps) is present in the SERP, the controller 301 can determine the variable as

if localpack is present then absolute (Position_{Locpack}−Position_{prediction})⁻¹) else 0

If an answerbox is present in the SERP, the controller 301 can determine the variable as

if answerbox is present then absolute(Position_{answerbox}−Position_{prediction})⁻¹) else 0

Consider an example where the location of the answer box is considered as ‘0’, the controller 301 can determine the variable as

if answerbox is present then absolute(Position_{prediction})⁻¹) else 0

The controller 301 can determine a plurality of interaction parameters (Branded:ln(Position) variable). The controller 301 can determine the interaction parameters by multiplying their values obtained from their base variables. Consider an example for the variable ln(Position), the controller 301 first checks the interested position of prediction. For example, if the interested position of prediction is 6, then the controller 301 considers 6 as the value of variable. The controller 301 calculates the interaction parameter by multiplying values in each of the branded and In (Position) variables.

The controller 301 can determine y as

y=Σβᵢxᵢ

where xᵢ is the parameter. y can depend on the SERP layout and can vary with changes in the SERP layout.

In an example herein, the controller 301 can determine y as

$$y = β 0 + β 1 ln ( Position ) + β 2 ( \frac{1}{count} ) + β3 ( Branded ) + β 4 {( Competition )}^{3} + β 5 ( News ) + β 6 ( Brandpack ) + β 7 ( Image ) + β 8 ( Local pack ) + β 9 ( people also ask ) + β 10 ( Answerbox ) + β 11 ( {Brandpack}_{match} ) + β 12 ( {Brandpack}_{links count} ) + β 13 \sqrt[3]{( Search volume )} + β 14 ( Branded \text{:} ln ( position ) ) + β 15 ( ln ( Position ) \text{:} {( Competition )}^{3} ) + β 16 ( ln ( Position ) \text{:} ( \frac{1}{count} ) ) + β 17 ( ln ( Position \text{:} \sqrt[3]{( Search volume )} ) + β 18 ( Branded \text{:} {Brandpack}_{match} ) + β 19 ( {( Competition )}^{3} \text{:} ( Answerbox ) ) \qquad Eq ( i )$$

### Where

position represents the position of interest in predicting the CTR;
count is the count of the keywords in the keyword;
competition is the competition value for the specific keyword, for which CTR has to be predicted;
Branded is a binary parameter that indicates whether the specific keyword is branded (‘1’ if it is branded and ‘0’ if it is not branded);
Brand pack match is the domain that is to be predicted; and
Brand pack links count is a count of the number of sitelinks present in the brand pack.

The controller 301 can then calculate the CTR as

$$CTR = \frac{{e}^{y}}{{e}^{y} + 1} \qquad Eq ( ii )$$

Based on the calculated CTR, the estimation module 302 can estimate a plurality of factors, such as traffic to a webpage, conversions/leads based on traffic, the total sales from the leads, and so on.

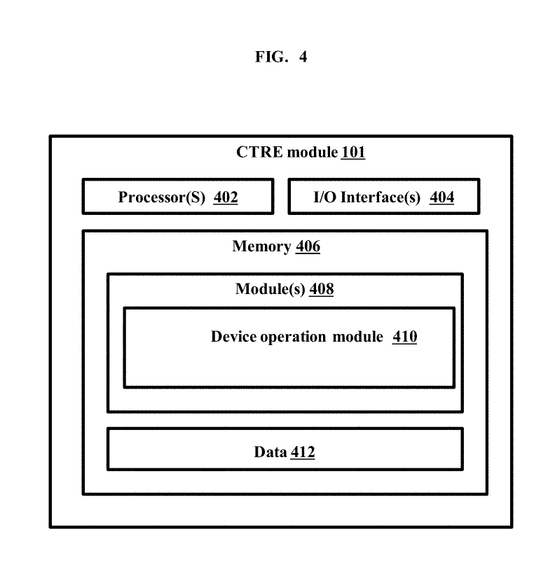

FIG. 4 illustrates a plurality of components of an electronic device for estimating the CTR. Referring to FIG. 4, the electronic device 400 is illustrated in accordance with an embodiment of the present subject matter. In an embodiment, the electronic device 400 may include at least one processor 402, an input/output (I/O) interface 404 (herein a configurable user interface), and a memory 406. The at least one processor 402 may be implemented as one or more microprocessors, microcomputers, microcontrollers, digital signal processors, central processing units, state machines, logic circuitries, and/or any devices that manipulate signals based on operational instructions. Among other capabilities, the at least one processor 402 is configured to fetch and execute computer-readable instructions stored in the memory 406.

The I/O interface 404 may include a variety of software and hardware interfaces, for example, a web interface, a graphical user interface such as a display screen, a camera interface for the camera sensor (such as the back camera and the front camera on the electronic device 400), and the like.

The 1/O interface 404 may allow the electronic device 400 to communicate with other devices. The I/O interface 404 may facilitate multiple communications within a wide variety of networks and protocol types, including wired networks, for example, Local Area network (LAN), cable, etc., and wireless networks, such as Wireless LAN, cellular, Device to Device (D2D) communication network, Wi-Fi networks and so on. The modules 408 include routines, programs, objects, components, data structures, and so on, which perform particular tasks, functions or implement particular abstract data types. In one implementation, the modules 408 may include a device operation module 410. The device operation module 410 can be configured to allow the user to handle one or more tasks of the application such as calculate the CTR. The device operation module 410 can be configured to fetch data from the database 102, calculate the CTR and estimating one or more factors from the calculated CTR. The device operation module can be configured to execute one or more tasks corresponding to the application on the electronic device 400 in accordance with embodiments as disclosed herein.

The modules 408 may include programs or coded instructions that supplement applications and functions of the electronic device 400. The data 412, amongst other things, serves as a repository for storing data processed, received, and generated by one or more of the modules 408. Further, the names of the other components and modules of the electronic device 400 are illustrative and need not be construed as a limitation.

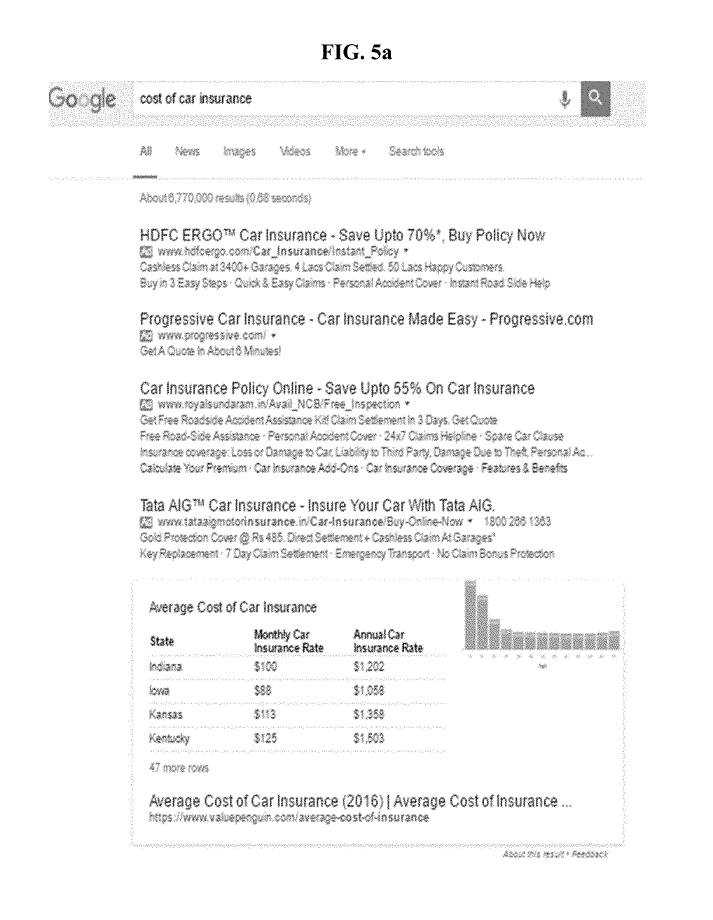

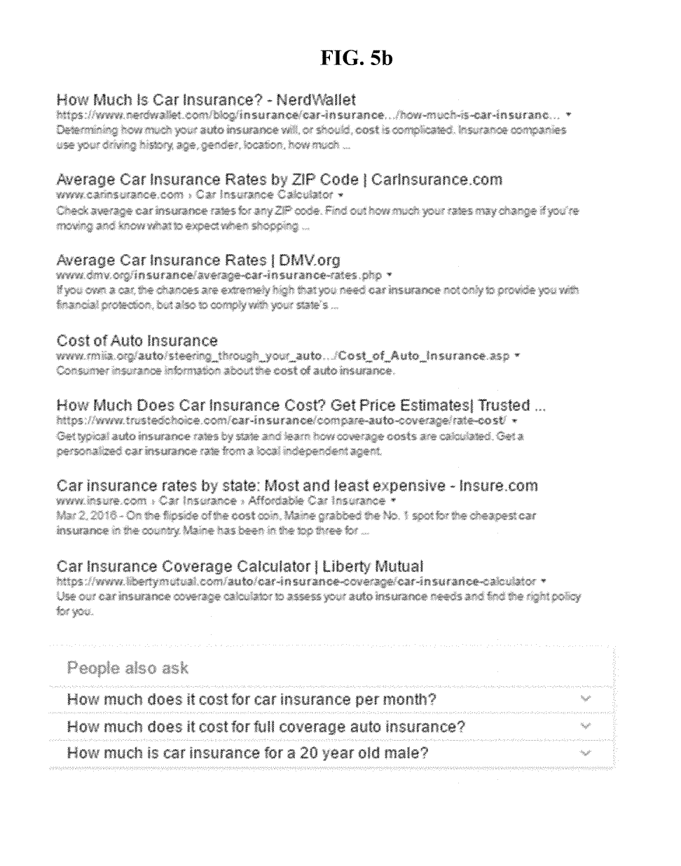

Consider an example, where there is a need to find the CTR on links ranking at various positions for the keyword “cost of car insurance” for a specific search engine. Embodiments disclosed herein can be used to find the CTR on links ranking at various positions for the keyword “cost of car insurance”. The CTRE module 101 can ping the search engine for the keyword and the obtain the data related to the SERP layout for the search engine. In the example FIGS. 5a and 5b, it can be seen that the answer box is present on the top of the results page and an ask pack is present at the end of the results page. The CTRE module 101 can quantify the impact of each of these packs on each ranking URL CTR by calculating relevant variables and determine the CTR at any interested position.

The embodiments disclosed herein can be implemented through at least one software program running on at least one hardware device and performing network management functions to control the network elements. The elements shown in FIGS. 1, 3 and 4 include blocks which can be at least one of a hardware device, or a combination of hardware device and software module.

The embodiment disclosed herein describes methods and systems for estimating CTR (Click-Through-Rate) for a SERP (Search Engine Results Page) layout. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for estimating CTR (Click-Through-Rate) for a SERP (Search Engine Results Page) layout, the method comprising
mapping data from webmasters data of various organizations/entities, and data related to the layout of SERP by a CTR estimation (CTRE) module, to obtain CTR and the SERP layout for each keyword;
building variables by the CTRE module by considering relative position of elements present in the SERP and using the mapped data;
determining commerciality and popularity of the keyword by the CTRE module using search volume and competition data related to keywords using adwords;
classifying the keyword as at least one of branded; and non-branded by the CTRE module;
obtaining number of tokens present in the keyword by the CTRE module; and
building a predictive model for estimating CTR by the CTRE module, by combining the built variables, the commerciality and popularity of the keyword, and the number of tokens.

2. The method, as claimed in claim 1, wherein the method further comprises of
estimating traffic to a webpage for a new keyword by the CTRE module using the predictive model; and
estimating conversions by the CTRE module using the estimated traffic and conversion rate of the webpage.

3. The method, as claimed in claim 1, wherein the method further comprises of
determining βᵢ by the CTRE module by performing regression analysis;
determining custom variable for each element of the SERP by the CTRE module as Pack Variable=(absolute(Position_{pack}−Position_{prediction})⁻¹);
determining a plurality of interaction parameters (Branded:ln(Position) variable) by the CTRE module by multiplying values in each of branded and ln(Position) variables;
determining y by the CTRE module as
y=Σβᵢxᵢ
where xᵢ is the parameter; and
estimating the CTR by the CTRE module
$$CTR = \frac{{e}^{y}}{{e}^{y} + 1} .$$

4. An apparatus operable to estimate CTR (Click-Through-Rate) for a SERP (Search Engine Results Page) layout, comprising:
a processor; and
a memory device, operatively connected to the processor, and having stored thereon instructions that, when executed by the processor, cause the processor to map data from webmasters data of various organizations/entities, and data related to the layout of SERP to obtain CTR and the SERP layout for each keyword;
build variables by considering relative position of elements present in the SERP and using the mapped data;
determine commerciality and popularity of the keyword using search volume and competition data related to keywords using adwords;
classify the keyword as at least one of branded; and non-branded;
obtain number of tokens present in the keyword; and
build a predictive model for estimating CTR, by combining the built variables, the commerciality and popularity of the keyword, and the number of tokens.

5. The apparatus, as claimed in claim 4, wherein the apparatus is further operable to estimate traffic to a webpage for a new keyword using the predictive model; and estimate conversions using the estimated traffic and conversion rate of the webpage.

6. The apparatus, as claimed in claim 4, wherein the apparatus is further operable to determine βᵢ by performing regression analysis;
determine custom variable for each element of the SERP as Pack Variable=(absolute(Position_{pack}−Position_{prediction})⁻¹);
determine a plurality of interaction parameters (Branded:ln(Position) variable) by multiplying values in each of branded and ln(Position) variables;
determiningy as
y=Σβᵢxᵢ
where xᵢ is the parameter; and
estimating the CTR as
$$CTR = \frac{{e}^{y}}{{e}^{y} + 1} .$$
